(19) United States
(12) Patent Application Publication
(10) Pub. No.: US 2025/0363525 A1
(43) Pub. Date: Nov. 27, 2025

(54) COLLABORATIVE COMPONENTS FRAMEWORK FOR CONTENT-BASED RECOMMENDATIONS SYSTEM

(71) Applicant: INTUIT INC., Mountain View, CA (US)

(72) Inventors: Yaakov TAYEB, Tel Aviv (IL); Hadas BAUMER, Tel Aviv (IL)

(73) Assignee: INTUIT INC., Mountain View, CA (US)

(21) Appl. No.: 18/674,732

(22) Filed: May 24, 2024

(51) Int. Cl. G06Q 30/0251

(52) U.S. Cl. CPC G06Q 30/0255

(57) ABSTRACT

A system for providing content-based (e.g., textual-based) recommendations. The system constructs a knowledge graph from campaign content data including nodes representing individual campaigns and edge weights representing text similarity and collaborative consumption between campaigns. The system adjusts the edge weights within the knowledge graph based on the collaborative consumption of customer groups to emphasize common keywords belonging to common customer groups and deemphasize keywords belonging to different customer groups. The system processes a new campaign content to align with interests of a closest customer group of the customer groups identified in the knowledge graph, thereby enabling targeted delivery of the new campaign to customers associated with that group.

### BACKGROUND

In the field of information retrieval and recommendation systems a knowledge graph typically includes nodes representing individual items or campaigns, and edges representing the relationships between these items. These relationships can be based on factors such as text similarity. Text similarity is often determined using natural language processing techniques, such as sentence embedding models, which convert text into numerical vectors that can be compared for similarity. Conventional systems, however, fail to adequately account for the dynamic nature of user interests and behavior. This can result in content being poorly matched to users, reducing the effectiveness of the recommendation system, which is undesirable.

### SUMMARY

Embodiments disclosed herein solve the aforementioned technical problems and may provide other technical solutions as well. Contrary to conventional techniques, the disclosed solution includes a novel method for content-based recommendations.

An example embodiment includes a system for providing content-based recommendations, comprising a knowledge graph constructing module configured to construct a knowledge graph from campaign content data, wherein the knowledge graph is constructed to include nodes representing individual campaigns and edge weights representing content similarity and collaborative consumption between campaigns, a reciprocal graph reintegration module configured to adjust the edge weights within the knowledge graph based on the collaborative consumption of customer groups, to emphasize common keywords belonging to common customer groups and deemphasize keywords belonging to different customer groups, and a content reformation module configured to process new campaign content to align with interests of a closest customer group of the customer groups identified in the knowledge graph, thereby enabling targeted delivery of the new campaign to customers associated with that group.

An example embodiment includes a method for providing content-based recommendations, comprising the steps of constructing a knowledge graph from campaign content data using a knowledge graph constructing module, wherein the knowledge graph includes nodes representing individual campaigns and edges with weights representing content similarity and collaborative consumption between campaigns, adjusting the edge weights within the knowledge graph based on the collaborative consumption of customer groups using a reciprocal graph reintegration module, to emphasize common keywords belonging to common customer groups and deemphasize keywords belonging to different customer groups, and processing new campaign content to align with interests of a closest customer group of the customer groups identified in the knowledge graph using a content reformation module, thereby enabling targeted delivery of the new campaign to customers associated with that group.

### BRIEF DESCRIPTION OF THE DRAWINGS

So that the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may apply to other equally effective example embodiments.

FIG. 1 is a block diagram of a system for providing recommendations, according to aspects of the present disclosure.

FIG. 2A is a diagram illustrating a network graph and a campaign content table, according to aspects of the present disclosure.

FIG. 2B is a process outlining the steps involved in building and revising a knowledge graph with collaborative components for a textual-based recommendations system, according to aspects of the present disclosure.

FIG. 3A is an overall process illustration for text reformation in a textual-based recommendation system, according to aspects of the present disclosure.

FIG. 3B is a process outlining a method for text reformation in a textual-based recommendation system similar to the example in FIG. 3A, according to aspects of the present disclosure.

FIG. 4A is a process integrating a new campaign in a textual-based recommendation system, according to aspects of the present disclosure.

FIG. 4B is a flowchart of a process for integrating a new campaign in a textual-based recommendation system similar to the example in FIG. 4A, according to aspects of the present disclosure.

FIG. 5 is a block diagram of a computing system diagram, according to aspects of the present disclosure.

### DETAILED DESCRIPTION OF SEVERAL EMBODIMENTS

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatuses as known by one of ordinary skill in the relevant art may not be discussed in detail but are intended to be part of the specification where appropriate. In the examples illustrated and discussed herein, any specific values should be interpreted to be illustrative and non-limiting. Thus, other example embodiments may have different values. It is noted that similar reference numerals and letters refer to similar items in the figures, and once an item is defined for one figure, it is possible that it need not be further discussed for the other figures.

To address the challenge of aligning content with the dynamic interests of users, the disclosed solution introduces a comprehensive framework that includes the construction of a user-specific knowledge graph that incorporates both textual and collaborative elements, the implementation of a reciprocal graph reintegration process, and the application of text reformation techniques.

A campaign knowledge graph is a user-centric knowledge graph that encapsulates the interactions of an individual user with various campaigns over a designated period. This graph is composed of nodes, each representing a distinct campaign, and two distinct types of edges. The first type, text similarity edges, are established between campaign nodes when their text embedding similarity, as determined by sentence embedding models surpasses a predefined threshold. The second type, collaborative edges, are formed when two or more readers engage with the same pair of campaigns. These edges are assigned a weight attribute corresponding to the number of distinct readers who have interacted with the content, thereby quantifying the strength of the collaborative connection.

Upon the initial construction of the knowledge graph, the reciprocal graph reintegration process commences. This process refines the graph by enhancing the text similarity within collaborative components, which are clusters of mutual interests, and by adjusting the similarity edges to better represent the presence or absence of interest groups. Reciprocal integration results in a filtered knowledge graph that retains similarity edges enriched with information about interest groups. During a text reformation phase, the initial campaigns are cleansed of words that contributed to biased similarity, ensuring that subsequent text embedding is based on content that encapsulates pertinent information, while excluding misleading terms.

The disclosed solution may begin with the assembly of the campaign knowledge graph, which is tailored to each user. This involves the aggregation of campaigns and user interactions over a specified timeframe, such as the previous three months. Nodes are created for each campaign, and text similarity is calculated using sentence embedding models. Collaborative connections are then identified and weighted based on the number of distinct readers sharing the same content consumption patterns.

The reciprocal graph reintegration step aims to amplify the text similarity within nodes that are part of the same collaborative component. This is achieved through a dual process of emphasizing similar words within the component and diminishing the strength of words shared by different collaborative components.

Various methods can be employed to modify text similarity scores. One such method is text stemming, which involves stemming the text within a component to identify and emphasize common words. Another method leverages Generative AI to rephrase texts, increasing the usage of specific words or removing them as per the requirements of emphasizing or minimizing similarity scores.

The text reformation process recalculates text similarity for each user based on the newly modified texts and reconstructs the knowledge graph with updated metrics. When new campaign content becomes available, it undergoes the same process to determine the closest user group for targeting, thereby enabling the delivery of campaigns to a subset of recipients likely to engage with the content. This targeted approach contrasts with the indiscriminate distribution of content, offering a more refined and effective method of engaging customers.

As mentioned above, the present disclosure relates to a system and method for providing content-based (e.g., textual-based) recommendations to a targeted audience of customers. More specifically, the disclosure pertains to a framework that constructs a user-specific knowledge graph from campaign content data, adjusts the graph based on collaborative consumption of customer groups, and processes new campaign content to align with the interests of the closest customer group identified in the knowledge graph. This framework, referred to as the collaborative components framework for content-based recommendations system, offers an approach to personalizing information dissemination and enhancing the effectiveness of marketing strategies. The disclosed solution is effectively designed to tailor content (e.g., textual-based content) to a targeted audience, rather than indiscriminately distributing content to all customers, which may lead to disengagement due to irrelevance. This targeted approach ensures that customers receive content that resonates with their individual preferences and behaviors, thereby increasing the likelihood of engagement and optimizing the overall effectiveness of content dissemination strategies.

By constructing a knowledge graph that includes both textual and collaborative components, the system can capture a more nuanced understanding of user interests and consumption patterns. The reciprocal graph reintegration process further refines this understanding by adjusting text similarity scores within the same collaborative components, thereby tuning the knowledge graph to reflect the existence of interest groups or the lack thereof. This results in a more accurate representation of user interests, which can be leveraged to deliver more personalized and relevant content.

In the context of a real-world application, consider a company specializing in outdoor gear aiming to target specific segments of its customer base with new promotional campaigns. The company could utilize the collaborative components framework for content-based recommendations system to construct a knowledge graph from customer interactions with various campaigns over the last quarter. The system can adjust the graph based on the collaborative consumption of customer groups, emphasizing common keywords within the same customer group and deemphasizing keywords belonging to different customer groups. Before launching a new campaign, the company could process the campaign text to align with the interests of the closest customer group identified in the knowledge graph, thereby enabling targeted delivery of the new campaign to customers associated with that group. This approach may increase the likelihood of engagement and reduce irrelevant outreach, fostering better customer relationships and improving marketing return on investment (ROI). For example, to target customers specifically interested in kayaking, the system would analyze campaign interactions related to outdoor water sports and identify customer groups with a high affinity for kayaking content. The knowledge graph and new campaigns would be created and then adjusted to emphasize kayaking-related keywords within these targeted customer groups, ensuring that new kayaking campaigns are aligned with their specific interests for more effective targeting.

While the present disclosure primarily describes a system and method for providing textual-based recommendations, it is worth noting that the disclosed framework is not limited to textual content alone. The collaborative components framework for textual-based recommendations system is equally applicable to other types of content-based recommendations, such as those involving video, audio, or multimedia content for consumption. The underlying principles of constructing a user-specific knowledge graph, adjusting the graph based on collaborative consumption, and processing new content to align with user interests are versatile and can be adapted to accommodate various content formats (e.g., embeddings, models, etc. may be adjusted to apply the method to content other than text). This adaptability allows for the personalization and targeting of content consumers across a diverse range of media, thereby broadening the scope and enhancing the applicability of the marketing strategies encompassed by this disclosure.

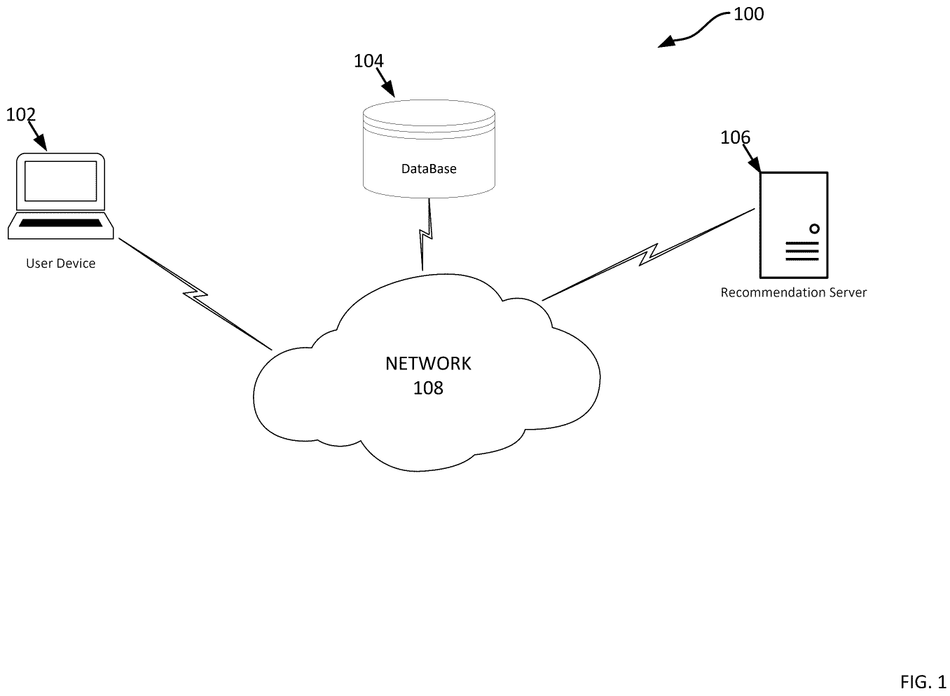

Referring now to FIG. 1, a system 100 for providing textual-based recommendations is now described. The system 100 includes a user device 102, a network cloud 108, a database 104, and a recommendation server 106. The user device 102 may be any type of computing device such as a personal computer, a tablet, a smartphone, or any other device capable of receiving and displaying content. The user device 102 is connected to the network cloud 108, which may represent any type of network, including but not limited to, the internet, a local area network (LAN), a wide area network (WAN), a virtual private network (VPN), or any combination thereof.

The database 104 is connected to the network cloud 108 and is configured to store various pieces of information. In some cases, the database 104 may store campaign content data collected from a plurality of sources, including social media platforms, email campaigns, and web advertisements. This data may include, but is not limited to, the content of the campaigns, user interaction data such as click-through rates, reading time, and sharing metrics, and any other relevant data.

The recommendation server 106 is also connected to the network cloud 108 and is configured to execute the novel solution described herein. The recommendation server 106 may include a knowledge graph constructing module and a reciprocal graph reintegration module. The knowledge graph constructing module may be configured to construct a knowledge graph from the campaign content data stored in the database 104. The knowledge graph may include nodes representing individual campaigns and edges representing text similarity and collaborative consumption between campaigns. The text similarity may be calculated using open-source sentence embedding models such as Bidirectional Encoder Representations from Transformers (BERT) or ‘all-MiniLM-L6-V2’ to name a few.

The reciprocal graph reintegration module may be configured to adjust the edge weights within the knowledge graph based on the collaborative consumption of customer groups. This adjustment may involve emphasizing common keywords belonging to common customer groups and deemphasizing keywords belonging to different customer groups. The reciprocal graph reintegration module may utilize user interaction data to identify the common customer groups and may dynamically adjust the edge weights in response to changes in user interaction data, ensuring that the knowledge graph reflects current consumption patterns. In some cases, the reciprocal graph reintegration module may apply a decay factor to the edge weights over time, to account for evolving interests of the common customer groups and maintain the relevance of the knowledge graph.

The user device 102 interacts with the recommendation server 106 via the network cloud 108. The recommendation server 106 accesses data from the database 104 to generate knowledge graphs and personalized recommendations. These recommendations are used to determine targeted recipients of the campaign, thereby enabling the delivery of more personalized and relevant content to the users.

It is noted that the hardware devices shown in FIG. 1 may include various “modules” which may be hardware, software or a combination of both hardware and software. The disclosure may reference such modules when describing the functionality of the system.

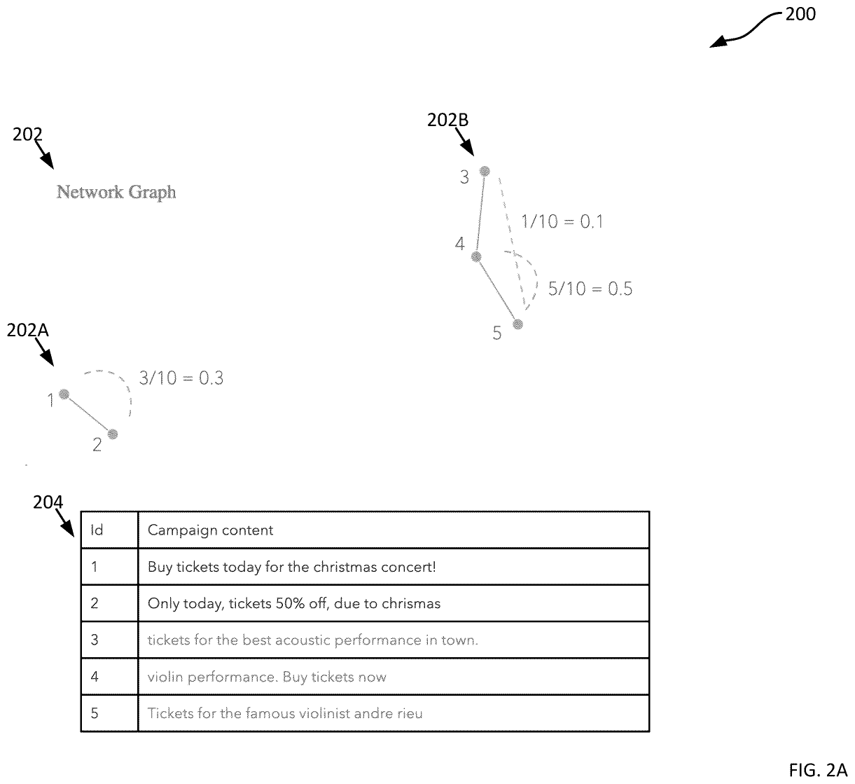

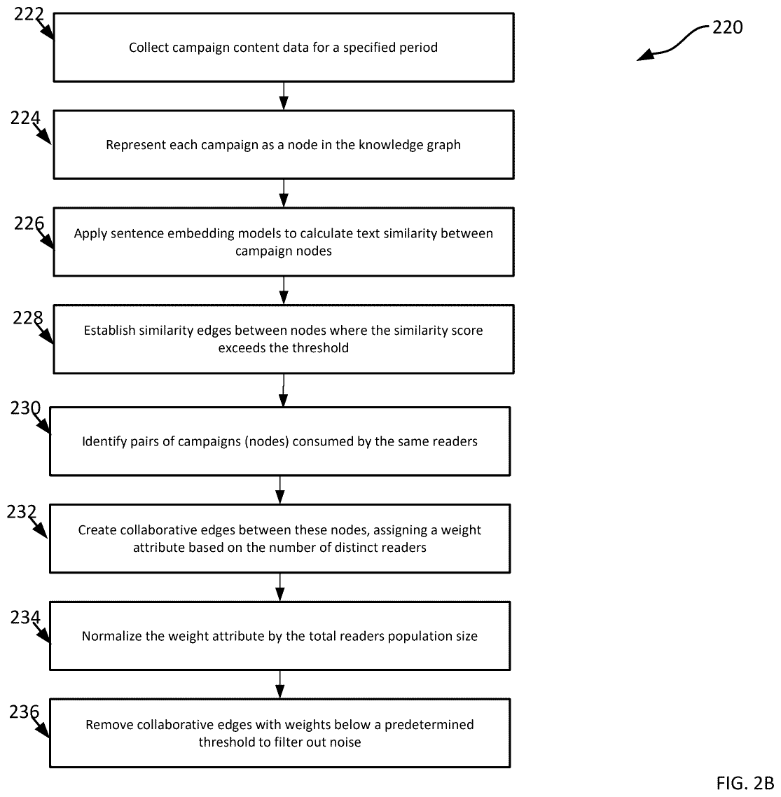

Details of the disclosed solution and specific examples will now be discussed with respect to the flowcharts and network graphs depicted in FIGS. 2A-4B.

These figures provide a visual representation of the various processes and structural components that constitute the collaborative components framework for textual-based recommendations system. Each figure illustrates an aspect of the system, from the construction of the knowledge graph to the integration of new campaign content, and the subsequent targeting of users based on refined collaborative consumption data. The flowcharts and network graphs serve as a guide to understanding the operational steps and the interrelationships between the campaigns, as well as the dynamic adjustments made to the knowledge graph in response to user behavior and new content.

Referring now to FIG. 2A, a diagram 200 is depicted illustrating a network graph 202 and a campaign content table 204. The network graph 202 shows collaborative connections between nodes 1 and 2, labeled as 202A, and between nodes 3, 4 and 5, labeled as 202B. These collaborative connections include dashed lines indicating edge weights, which are the strength of the collaborative connections based on the number of distinct readers that consumed the same or similar campaigns. The campaign content table 204 lists the campaign content associated with each node, providing context for the collaborative connections shown in the network graph 202.

In some aspects, the knowledge graph constructing module, which is part of system 100, may represent each campaign as a node within the knowledge graph based on the campaign content data. This data may be collected from various sources, such as social media platforms, email campaigns, and web advertisements. Each node in the network graph 202 represents distinct campaigns, and the edges between the nodes represent the relationships between these campaigns. These relationships may be based on text similarity and collaborative consumption, as indicated by the dashed lines in the network graph 202.

In some aspects, the reciprocal graph reintegration module, which is also part of system 100, may adjust the edge weights within the network graph 202 based on the collaborative consumption of customer groups. This adjustment may involve increasing the edge weights for pairs of campaign nodes that are consumed by a collaborative group of readers, thereby enhancing the text similarity within the collaborative group. For instance, the collaborative connection between nodes 1 and 2, labeled as 202A, may be strengthened if these campaigns are frequently consumed by the same group of readers.

Conversely, the reciprocal graph reintegration module may decrease the edge weights for pairs of campaign nodes that are not consumed by the same collaborative group of readers, thereby reducing the text similarity across different collaborative groups. For example, if nodes 3, 4 and 5, labeled as 202B, are not commonly consumed by the same group of readers, the text similarity between these nodes may be reduced.

In some embodiments, the knowledge graph constructing module may apply a threshold to determine whether a similarity edge is created between campaign nodes based on their text similarity scores. If the text similarity score between two campaign nodes exceeds this threshold, a similarity edge may be created between these nodes in the network graph 202. This threshold may be adjustable based on various factors, such as the specific requirements of the campaign or the preferences of the users.

The campaign content table 204 provides a detailed view of the campaign content associated with each node in the network graph 202. This table may include various pieces of information about each campaign, such as the campaign title, description, target audience, and other relevant details. This information may be used to provide context for the collaborative connections shown in the network graph 202 and to assist in the process of adjusting the edge weights within the network graph 202 based on the collaborative consumption of customer groups.

Nodes 1 and 2 within the network graph 202, as indicated by the collaborative connection labeled 202A, are connected due to shared campaign content consumption patterns among a specific group of readers. For example, the connection between nodes 1 and 2 in the network graph 202 may be due to their campaign content being thematically focused on Christmas. This connection is strengthened by the frequent consumption of these campaigns by the same group, suggesting a shared interest or preference that is captured by the knowledge graph. The collaborative consumption data, which includes metrics such as click-through rates and reading time, reveals a strong relationship between these campaigns, leading to a higher edge weight and indicating a higher text similarity within this customer group.

On the other hand, nodes 3, 4, and 5, connected by the collaborative connection labeled 202B, are linked due to their association with a different segment of the customer base. For example, the connection between nodes 3, 4 and 5 in the network graph 202 may be due to their campaign content being thematically focused on acoustic performances. Although the content in nodes 1 and 2 may share some similarity with the content in nodes 3, 4 and 5 (e.g., concert, violin performance, acoustic performance, etc.), the distinct readership patterns suggest that they cater to different interests or preferences (e.g., one audience for Christmas and the other audience for acoustic performances). The reciprocal graph reintegration module may consequently reduce the edge weights between these nodes, reflecting a lower text similarity and distinguishing the separate collaborative groups. This differentiation allows the system to more accurately target campaign content to the respective customer groups, enhancing the relevance and effectiveness of the recommendations.

Referring now to FIG. 2B, a process 220 outlining the steps involved in building a knowledge graph with collaborative components for a textual-based recommendations system is now described. The process 220 begins with the data collection step 222, where campaign content data is collected for a specified period. This data may be collected from a plurality of sources, including social media platforms, email campaigns, and web advertisements. In some cases, the data collection step 222 may involve gathering user interaction data, such as click-through rates, reading time, and sharing metrics, to provide a comprehensive view of user engagement with the campaigns.

Following the data collection step 222, the node representation step 224 is performed, where each campaign is represented as a node in the knowledge graph. The nodes may represent individual campaigns, and the edges between the nodes may represent the relationships between these campaigns based on text similarity and collaborative consumption.

The text similarity calculation step 226 involves applying natural language processing (NLP) techniques to determine text similarity scores between pairs of campaign nodes. In some aspects, the NLP techniques may include the use of sentence embedding models, such as BERT or ‘all-MiniLM-L6-V2’, to determine the text similarity scores between the campaign nodes. These models are capable of capturing the contextual nuances of the text, allowing for a more accurate assessment of similarity beyond simple keyword matching. The BERT model, for example, uses a transformer architecture that processes words in relation to all the other words in a sentence, rather than one-by-one in order. The ‘all-MiniLM-L6-V2’ model, on the other hand, is optimized for efficiency and speed while maintaining high performance in similarity scoring tasks. The knowledge graph constructing module may leverage these models to compute vector representations of the text from each campaign node, which are compared using cosine similarity or other appropriate metrics to quantify the degree of similarity between campaigns. The resulting similarity scores are used to establish the edges between nodes in the knowledge graph, with higher scores indicating greater similarity and stronger connections.

The similarity edges establishment step 228 is where similarity edges are established between nodes where the similarity score exceeds a predetermined threshold. For instance, if the text similarity score between two campaign nodes exceeds a threshold, a similarity edge may be created between these nodes. The campaign pairs identification step 230 identifies pairs of campaigns (nodes) consumed by the same readers. This step may involve analyzing user interaction data to identify common patterns of consumption, thereby revealing groups of readers with similar interests. In the collaborative edges creation step 232, collaborative edges are created between these nodes, assigning a weight attribute based on the number of distinct readers. The weight attribute may reflect the strength of the collaborative connection between the nodes, with a higher weight indicating a stronger connection. The weight attribute normalization step 234 normalizes the weight attribute by the total readers population size. This normalization process may help to ensure that the weight attributes are proportional and comparable across different collaborative connections. The collaborative edges filtering step 236 removes collaborative edges with weights below a predetermined threshold to filter out noise. This step may help to ensure that the knowledge graph accurately reflects the strong collaborative connections between campaigns, while eliminating weak or random connections that may not be indicative of genuine common user interests.

In some aspects, the process 220 may be dynamically adjusted in response to changes in user interaction data, ensuring that the knowledge graph reflects current consumption patterns. For instance, the reciprocal graph reintegration module, which is part of system 100, may dynamically adjust the edge weights in response to changes in user interaction data. In some cases, the reciprocal graph reintegration module may apply a decay factor to the edge weights over time, to account for evolving interests of the common customer groups and maintain the relevance of the knowledge graph. In other words, the graph is evolving (e.g. continuously, periodically, etc.) as users interact with campaign content and the interaction information is evaluated by the system.

The detailed steps outlined in FIG. 2B provide a comprehensive methodology for refining the content depicted in FIG. 2A to achieve the desired solution for a textual-based recommendations system. These steps encompass the collection of campaign content data, the representation of campaigns as nodes within a knowledge graph, and the calculation of text similarity scores using advanced NLP techniques. The process further includes the establishment of similarity edges based on these scores, the identification of campaign pairs consumed by the same readers, and the creation and normalization of collaborative edges. By dynamically adjusting edge weights in response to user interaction data and applying a decay factor over time, the system ensures that the knowledge graph remains current and reflective of user interests, thereby enhancing the accuracy and relevance of campaign recommendations. The steps as depicted in FIG. 2B, will now be described in detail with respect to the remaining figures.

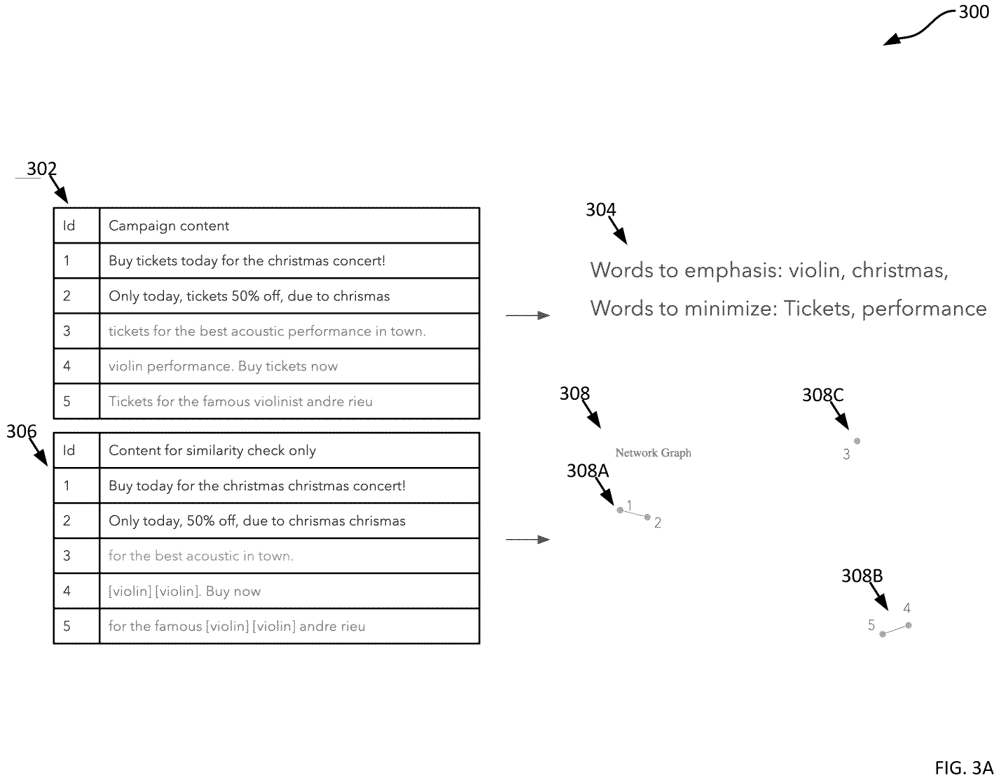

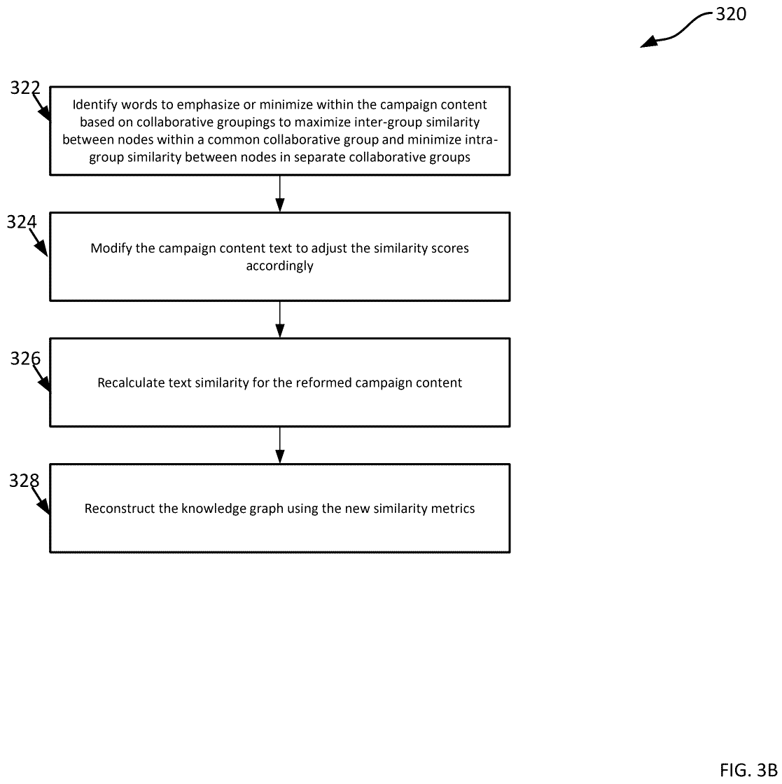

Referring now to FIG. 3A, a process illustration 300 for text reformation in a knowledge graph system is depicted and now described. The process illustration 300 includes an original campaign content table 302, text reformation instructions 304, a modified campaign content table 306, and a campaign relationship network graph 308.

The original campaign content table 302 lists various campaign content with their respective IDs. In some aspects, the campaign content may include any form of information or message that is intended to be disseminated to users, such as advertisements, promotional offers, news updates, or any other type of content. The campaign content may be represented in various formats, including but not limited to, text, images, videos, audio, or any combination thereof. In this specific example, the campaign content includes ID1: Buy tickets today for the christmas concert!; ID2: Only today, tickets 50% off, due to christmas; ID3: tickets for the best acoustic performance in town.; ID4: violin performance. Buy tickets now; and ID5: Tickets for the famous violinist andre rieu.

The text reformation instructions 304 provide guidance on which words to emphasize and which to minimize within the campaign content. In some cases, the text reformation instructions 304 may be generated by the reciprocal graph reintegration module of the recommendation server 106. The reciprocal graph reintegration module may use various techniques to determine which words to emphasize or minimize. For instance, the module may use text stemming to find the common words within a collaborative component that are to be emphasized. Text stemming is a process of reducing inflected words to their stem, base or root form.

For example, the word “violin” in the campaign content may be strategically chosen to emphasize to strengthen the connection between the group of nodes 1 and 2, as indicated by the collaborative connection labeled 202A in the network graph 202. This emphasis is based on the observed consumption patterns that suggest a shared interest in violin-related content among the readers associated with these nodes. By emphasizing “violin,” the system enhances the text similarity within this customer group, leading to a more robust and meaningful connection within the knowledge graph.

Similarly, the word “christmas” in the campaign content may be strategically chosen to emphasize to strengthen the connection between the group of nodes 3, 4, and 5, as represented by the collaborative connection labeled 202B. The emphasis on “christmas” aligns with the thematic focus of the campaigns associated with these nodes and the consumption patterns of the readers who frequently engage with Christmas-related content. This targeted emphasis serves to increase the text similarity scores within this particular customer group, thereby solidifying the collaborative connection within the knowledge graph (e.g. increasing correlation between the nodes 1 and 2, and increasing correlation between the nodes 3, 4 and 5).

Conversely, the words “tickets” and “performance” may be strategically chosen to be de-emphasized as they are found to weaken the connections between the two distinct groups of nodes. While these words may be common across various campaigns, their general nature does not contribute to the specificity and distinctiveness of the customer groups' interests. By deemphasizing these words, the system reduces the text similarity across different collaborative groups, which helps to maintain clear differentiation between the groups (e.g., reducing correlation between the group including nodes 1 and 2 with respect to the group including nodes 3, 4 and 5). This differentiation is beneficial for the system's ability to deliver more accurately targeted campaign content, ensuring that the recommendations are tailored to the nuanced preferences of each customer group.

The modified campaign content table 306 shows the adjusted text after reformation, with the words emphasized or minimized according to the instructions. The modified campaign content may be used to recalculate the text similarity scores and reconstruct the knowledge graph.

The campaign content table 306 reflects strategic modifications to the text of the campaigns to enhance the collaborative connections within the knowledge graph. Specifically, the word “christmas” was duplicated in the content of nodes 1 and 2 to increase the connection between these nodes, as they share a thematic focus on Christmas-related content. This duplication serves to reinforce the text similarity within this customer group, leading to a stronger and more meaningful connection within the knowledge graph.

Similarly, the word “violin” was duplicated in the content of nodes 3, 4, and 5 to increase the connection between these nodes, which are associated with a shared interest in violin-related content. The duplication of “violin” in these campaigns emphasizes this common theme, thereby enhancing the text similarity scores within this particular customer group and solidifying the collaborative connection within the knowledge graph.

Conversely, the words “tickets” and “performance” were removed from the campaign content to weaken the connections between the distinct groups of nodes. These words, while common across various campaigns, do not contribute to the specificity and distinctiveness of the customer groups' interests. By removing these words, the system reduces the text similarity across different collaborative groups, helping to maintain clear differentiation between the groups. This differentiation is beneficial for the system's ability to deliver more accurately targeted campaign content, ensuring that the recommendations are tailored to the nuanced preferences of each customer group.

The reformed campaign content table 306, therefore, presents the adjusted text with the words “christmas” and “violin” emphasized to strengthen intra-group connections and the words “tickets” and “performance” minimized to reduce inter-group text similarity. These adjustments are reflected in the recalculated text similarity scores and the reconstructed knowledge graph, enabling the system to provide more personalized and effective recommendations.

The campaign relationship network graph 308 visually represents the relationships between the campaigns after text reformation. The network graph 308 includes nodes representing individual campaigns and edges representing text similarity and collaborative consumption between campaigns. The similarity edge between nodes 1 and 2 is labeled as 308A and the similarity edge between nodes 4 and 5 is labeled as 308B. Node 3 is shown as isolated, labeled as 308C, indicating that it does not share a substantial similarity with the other nodes after the reformation process.

In the case of node 3, labeled as 308C in the campaign relationship network graph 308, it is depicted as isolated due to the absence of emphasis words and the removal of words for deemphasis. Initially, node 3 was considered to be connected to nodes 4 and 5, suggesting a potential collaborative grouping. However, upon further analysis by the system, it was determined that node 3's campaign content did not share a substantial thematic or interest-based similarity with the content of nodes 4 and 5. The text reformation instructions 304, which guided the emphasis and minimization of specific words, did not identify any words within node 3's content that warranted emphasis to align with the other nodes. Conversely, words that were common, but not indicative of a shared interest, such as “tickets” and “performance,” were minimized, further distancing node 3 from the group. This strategic adjustment in the text reformation process led to the realization that node 3's content is distinct and does not belong to the collaborative group represented by the connection labeled 202B. As a result, the system accurately reflects node 3 as an isolated node, ensuring that the knowledge graph maintains a clear and accurate representation of user interests and campaign relationships.

The campaign relationship network graph 308 may be dynamically updated in response to changes in user interaction data or campaign content data. For instance, if a new campaign is launched or an existing campaign is updated, the text reformation process may be applied to the new or updated campaign content, and the network graph 308 may be updated to reflect the new relationships between the campaigns. This dynamic updating of the network graph 308 ensures that the graph accurately reflects the current state of the campaigns and user interests, thereby enabling the delivery of more personalized and relevant content to the users.

Referring now to FIG. 3B, a process 320 outlining a method for refining a textual-based recommendation system, as shown for example in FIG. 3A is now described. The process 320 begins with the word identification step 322, where words to emphasize or minimize within the campaign content are identified based on collaborative groupings. This step may involve analyzing the campaign content data and user interaction data to identify common patterns of consumption and common keywords within the same collaborative group. The identified words may be used to increase (e.g., maximize) inter-group similarity and decrease (e.g., minimize) intra-group similarity.

During the word identification step 322, the system employs advanced analytics to dissect the campaign content data, utilizing algorithms such as term frequency-inverse document frequency (TF-IDF) to discern the prominence of specific terms within the content corpus. This statistical measure evaluates how relevant a word is to a document in a collection of documents, thereby identifying keywords that are associated with particular collaborative groups. Additionally, the system may implement clustering algorithms, like K-means or hierarchical clustering, to detect natural groupings of campaigns based on user engagement metrics. These clusters help in pinpointing shared interests among customer groups, which are then used to guide the emphasis or minimization of words.

Furthermore, the system may leverage machine learning models, such as neural networks or support vector machines, trained on historical interaction data to predict potential collaborative consumption patterns. These models can classify new campaigns into existing customer interest groups with high accuracy, ensuring that the words identified for emphasis or minimization are truly reflective of the dynamic preferences of the user base.

The output of step 322 is a refined list of keywords tailored to enhance the collaborative components of the knowledge graph. This list relies on the frequency of terms as well as their contextual relevance and the strength of their association with user behavior patterns. By integrating these analytical techniques, the system ensures that the word identification process is both data-driven and context-aware, leading to a more nuanced and effective text reformation strategy.

In the campaign content modification step 324, the campaign content text is modified to adjust the similarity scores accordingly. This modification may involve emphasizing the identified words within the same collaborative group and minimizing the identified words across different collaborative groups. In some aspects, the modification of the campaign content text may be performed by the reciprocal graph reintegration module of the recommendation server 106. The reciprocal graph reintegration module may use various techniques to modify the campaign content text, such as text stemming or the use of generative AI models.

To elaborate on the campaign content modification step 324, the reciprocal graph reintegration module employs a series of text processing algorithms to enhance the relevance of the campaign content. Initially, the module applies text stemming to reduce words to their base or root form, ensuring that variations of a word are treated uniformly. For example, “running,” “runner,” and “ran” may all be stemmed to the root “run.” This normalization process aids in the accurate identification of emphasis words across different campaigns.

Subsequently, the module utilizes a keyword augmentation algorithm to emphasize identified words within the same collaborative group. This algorithm selectively increases the frequency of emphasis words in the campaign content, thereby artificially inflating their presence and perceived relevance. The augmentation process may involve duplicating the emphasis words or adding synonyms that carry similar thematic weight, effectively strengthening the text similarity within the collaborative group.

Conversely, for words identified to be minimized across different collaborative groups, the module implements a keyword dilution algorithm. This algorithm strategically reduces the prominence of such words by either removing them or replacing them with less specific terms. The dilution process decreases the likelihood of these words creating false connections between disparate collaborative groups, thereby reducing inappropriate text similarity.

In addition to these techniques, the reciprocal graph reintegration module may leverage generative AI models to rewrite sections of the campaign content. These models, trained on extensive datasets, can generate new text passages that naturally incorporate emphasis words while phasing out minimized words. The generative models ensure that the reformed content remains coherent and engaging, despite the alterations made to optimize text similarity scores.

The output of the campaign content modification step 324 is a set of reformed campaign texts that are finely tuned to reflect the collaborative consumption patterns identified in the knowledge graph. These modifications are designed to enhance the accuracy of the knowledge graph and improve the efficacy of the textual-based recommendation system.

The text similarity recalculation step 326 involves recalculating the text similarity for the reformed campaign content. This step may involve applying NLP techniques, such as sentence embedding models, to recalculate the text similarity scores between the reformed campaign nodes. The recalculated text similarity scores may reflect the adjustments made to the campaign content text in the campaign content modification step 324.

The text similarity recalculation step 326 is a component of the process, where the text similarity scores for the reformed campaign content are recalculated. This recalculation is performed using advanced NLP techniques, which may include a variety of sentence embedding models. These models are designed to capture the semantic meaning of text by converting sentences into high-dimensional vectors.

During this step, the reformed campaign content is fed into pre-trained sentence embedding models such as Bidirectional Encoder Representations from Transformers (BERT), Generative Pre-trained Transformer (GPT), or Universal Sentence Encoder (USE) to name a few. These models generate vector representations for each piece of reformed campaign content. The vectors are then compared using similarity metrics such as cosine similarity, Euclidean distance, Jaccard index or the like to quantify the degree of similarity between the reformed campaign nodes.

The recalculated text similarity scores are a reflection of the adjustments made to the campaign content text during the campaign content modification step 324. By emphasizing or minimizing specific words, the semantic context of the campaign content is altered, which is then captured by the updated vector representations. The recalculated scores are used to update the edges within the knowledge graph, ensuring that the graph accurately represents the current textual relationships between the campaigns.

To ensure the robustness of the recalculated similarity scores, the NLP models may be fine-tuned on domain-specific corpora, allowing the models to better understand the context and jargon of the campaign content. Additionally, the recalculated scores are normalized to account for variations in text length and to maintain consistency across the knowledge graph.

The output of the text similarity recalculation step 326 is a set of updated text similarity scores that are used to refine the knowledge graph, enabling the system to provide more accurate and relevant textual-based recommendations.

The knowledge graph reconstruction step 328 is where the knowledge graph is reconstructed using the new similarity metrics. This step may involve updating the nodes and edges of the knowledge graph to reflect the reformed campaign content and the recalculated text similarity scores. The reconstructed knowledge graph may provide a more accurate representation of user interests and consumption patterns, thereby enabling the delivery of more personalized and relevant content to the users.

In the knowledge graph reconstruction step 328, the system undertakes a comprehensive update of the knowledge graph's structure to incorporate the recalculated text similarity metrics derived from the reformed campaign content. This reconstruction is a multi-faceted process that involves several technical details.

For example, the system may identify any changes in the text similarity scores that necessitate an update to the existing nodes and edges. This includes adding new nodes for any newly introduced campaigns and removing nodes for campaigns that are no longer relevant. Edges are then added, removed, or updated based on the recalculated text similarity scores, ensuring that the strength of the connections accurately reflects the current textual relationships between campaigns.

The system may optimize the knowledge graph for efficient querying and processing, the system may implement graph optimization algorithms. These algorithms are designed to minimize the complexity of the graph while preserving the integrity of the relationships between nodes. Techniques such as edge pruning, node clustering, and graph compression may be employed to streamline the graph structure.

In addition, the system may adjust the collaborative consumption data within the knowledge graph. This involves recalibrating the edge weights to reflect the latest collaborative consumption patterns among user groups. The system may use time-decay models to diminish the influence of older interactions and amplify recent user behaviors, ensuring that the graph remains dynamic and up-to-date.

Once the updates are applied, the system may perform a validation check to ensure the integrity of the knowledge graph. This includes verifying that all nodes and edges conform to the defined schema, checking for data consistency, and ensuring that there are no orphaned nodes or disconnected components that could affect the accuracy of the recommendations.

The system may map the updated knowledge graph to the identified interest groups within the user base. This mapping allows for the identification of the closest customer group for each campaign node, facilitating targeted content delivery. The mapping process may involve the use of community detection algorithms to identify densely connected subgraphs that represent distinct interest groups.

The reconstructed knowledge graph may be stored in a graph database that supports efficient retrieval and manipulation of graph data. The system creates indexes on the nodes and edges based on attributes such as campaign ID, text similarity score, and collaborative consumption metrics, which accelerates the search and recommendation processes.

To maintain the knowledge graph's relevance, the system is designed to support incremental updates. As new campaign content is introduced or user interactions evolve, the system can apply partial updates to the graph without the need for a full reconstruction. This incremental approach ensures that the knowledge graph remains responsive to changes while minimizing computational overhead. In other words, process 320 may be dynamically adjusted in response to changes in user interaction data or campaign content data. For instance, if a new campaign is launched or an existing campaign is updated, the process 320 may be applied to the new or updated campaign content, and the knowledge graph may be updated to reflect the new relationships between the campaigns. This dynamic updating of the process 320 ensures that the knowledge graph accurately reflects the current state of the campaigns and user interests, thereby enabling the delivery of more personalized and relevant content to the users.

It should also be noted that the reciprocal graph reintegration module of the recommendation server 106 may use generative AI models to emphasize and minimize similarity scores. These models may be used to generate new text that emphasizes the identified words within the same collaborative group and minimizes the identified words across different collaborative groups. The use of generative AI models may provide a more sophisticated and nuanced approach to text reformation, thereby enhancing the effectiveness of the textual-based recommendation system.

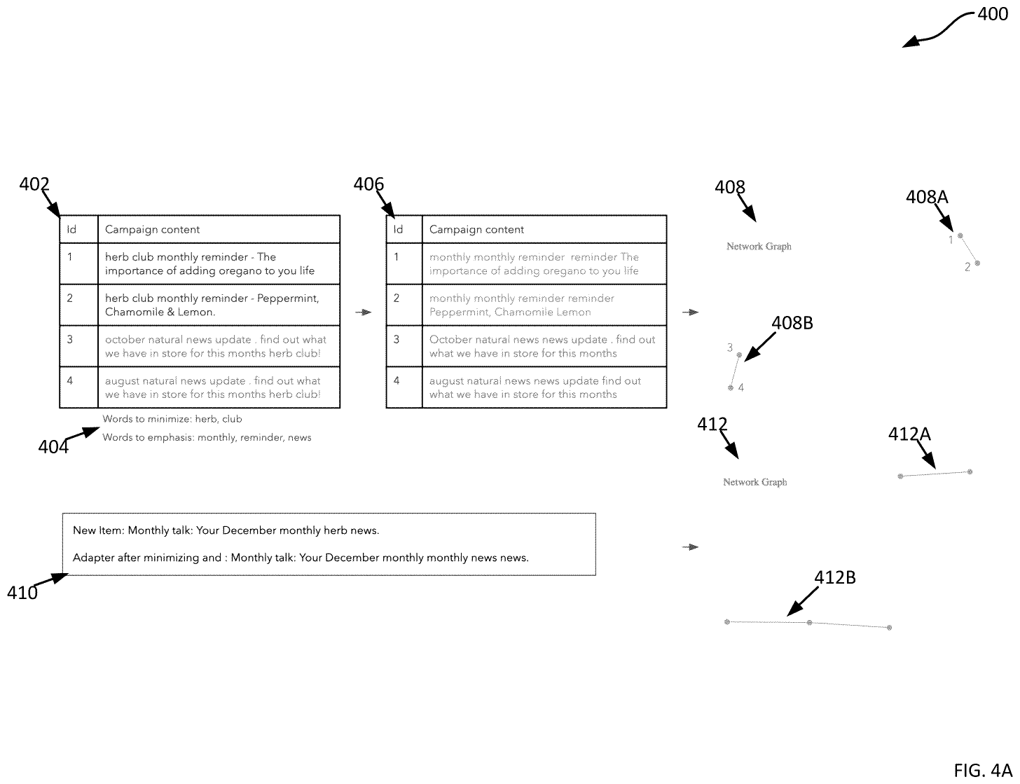

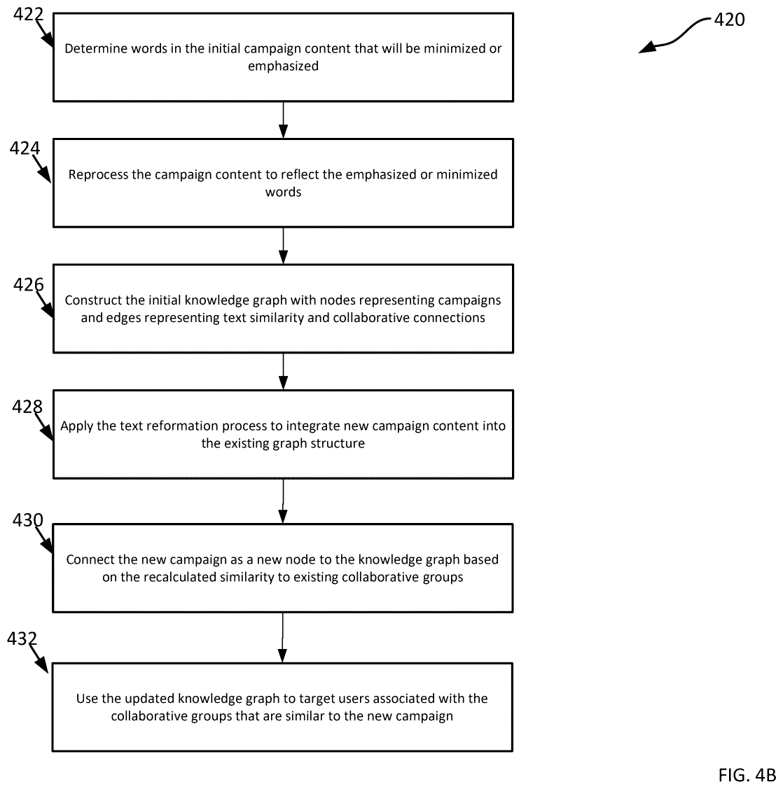

Referring now to FIG. 4A, a process 400 for a textual-based recommendation system is depicted with respect to a new campaign. The process 400 includes an initial campaign content table 402, text reformation instructions 404, a reprocessed campaign content table 406, an initial network graph 408, new campaign content 410, and a reformed network graph 412 with integrated new campaign.

The initial campaign content table 402 lists various campaign content with their respective IDs. In some aspects, the campaign content may include any form of information or message that is intended to be disseminated to users, such as advertisements, promotional offers, news updates, or any other type of content. The campaign content may be represented in various formats, including but not limited to, text, images, videos, audio, or any combination thereof.

The text reformation instructions 404 provide guidance on which words to emphasize and which to minimize within the campaign content. In some cases, the text reformation instructions 404 may be generated by the reciprocal graph reintegration module of the recommendation server 106. The reciprocal graph reintegration module may use various techniques to determine which words to emphasize or minimize.

In this example, the words “herb” and “club” are strategically chosen to be minimized in the campaign content. This minimization is based on the analysis that these words do not contribute to the specificity and distinctiveness of the customer groups' interests. By reducing the prominence of “herb” and “club,” the system aims to decrease the likelihood of these words creating false connections between disparate collaborative groups, thereby reducing inappropriate text similarity.

Conversely, the words “monthly,” “reminder,” and “news” are identified to be emphasized within the campaign content. The emphasis on these words is informed by their relevance to the thematic focus of the campaigns and the observed consumption patterns of the readers. By increasing the presence of “monthly,” “reminder,” and “news” in the campaign content, the system enhances the text similarity within the collaborative groups that show a shared interest in these topics. This targeted emphasis serves to strengthen the collaborative connections within the knowledge graph, leading to a more robust and meaningful representation of user interests and preferences.

The reprocessed campaign content table 406 shows the adjusted text after reformation, with the words emphasized or minimized according to the instructions mentioned above. The reprocessed campaign content may be used to recalculate the text similarity scores and reconstruct the knowledge graph 408 represents the reprocessed nodes from campaign content table 406 such as the reprocessed relationship 408A between nodes 1 and 2, and the reprocessed relationship 408B between nodes 3 and 4.

The network graph 408 may be dynamically updated in response to changes in user interaction data or campaign content data. For instance, if a new campaign is launched or an existing campaign is updated, the text reformation process may be applied to the new or updated campaign content, and the network graph 408 may be updated to reflect the new relationships between the campaigns.

For example, new campaign content 410 is prepared for integration into the system. In some cases, the new campaign content 410 may be processed according to the text reformation instructions 404 before it is integrated into the system. This processing may involve emphasizing or minimizing specific words within the new campaign content 410 based on the collaborative groupings identified in the knowledge graph. The processed new campaign content 410 may be used to recalculate the text similarity scores and update the knowledge graph.

In this example, the original new content, which may have been manually entered or automatically generated by an LLM is “Monthly talk: Your December monthly herb news”. Upon being modified by the text reformation instructions 404, the revised new campaign content is transformed to “Monthly talk: Your December monthly monthly news news”. This modification is a direct result of the emphasis placed on the words “monthly” and “news” as per the instructions, which are duplicated to enhance their presence in the campaign content. Conversely, the word “herb” is minimized, resulting in its removal from the revised campaign content. The reformed text is designed to align more closely with the interests of the closest customer group identified in the knowledge graph, thereby increasing the relevance and potential engagement of the targeted audience.

Network graph 408 is updated into reformed network graph 412, including reprocessed relationship 412A between nodes 1 and 2, and the reprocessed relationship 412B between nodes 3, 4 and new node 5 after integrating the new campaign content 410 into the system. In other words, the reformed network graph 412 provides a visual representation of the relationships between the campaigns after the integration of the new campaign content 410. The nodes in the reformed network graph 412 represent individual campaigns, and the edges represent the text similarity and collaborative consumption between campaigns. The reformed network graph 412 may be used to target users associated with the collaborative groups that are similar to the new campaign (e.g. groups associated with nodes 3, 4 and 5), thereby enabling the delivery of more personalized and relevant content to the users. It is noted that the modified new campaign with repeated and removed words are for adjusting the network graph and are not sent to the users. The new campaign is sent as originally generated without the repeated or removed words. For example, the campaign “Monthly talk: Your December monthly herb news” may be sent to users associated with groups 3, 4 and 5.

In some variations, the process 400 may include tracking words to be emphasized and removed in the text reformation module of the recommendation server 106 for reuse, instead of calculating them each time. This variation may enhance the efficiency of the process 400 by reducing the computational resources and time spent on recalculating the words to be emphasized or minimized. This variation may be particularly beneficial in scenarios where the campaign content data is large or frequently updated.

Referring now to FIG. 4B, a process 420 for integrating new campaign content into a knowledge graph and targeting users such as the example shown in FIG. 4A is now described. The process 420 begins with the word determination step 422, where words in the initial campaign content that will be minimized or emphasized are identified. This step may involve analyzing the campaign content data and user interaction data to identify common patterns of consumption and common keywords within the same collaborative group. The identified words may be used to increase (e.g., maximize) inter-group similarity and decrease (e.g., minimize) intra-group similarity.

The content reprocessing step 424 is performed to reprocess the campaign content text to reflect the emphasized or minimized words. This reprocessing may involve emphasizing the identified words within the same collaborative group and minimizing the identified words across different collaborative groups. In some aspects, the reprocessing of the campaign content text may be performed by the reciprocal graph reintegration module of the recommendation server 106. The reciprocal graph reintegration module may use various techniques to reprocess the campaign content text, such as text stemming or the use of generative AI models.

The knowledge graph construction step 426 involves constructing the initial knowledge graph with nodes representing campaigns and edges representing text similarity and collaborative connections. The nodes may represent individual campaigns, and the edges between the nodes may represent the relationships between these campaigns based on text similarity and collaborative consumption. In some cases, the knowledge graph construction step 426 may involve applying NLP techniques, such as sentence embedding models, to calculate the text similarity scores between the campaign nodes.

The text reformation application step 428 applies the text reformation process to integrate new campaign content into the existing graph structure. This step, as mentioned above, may involve reprocessing the new campaign content to align with the interests of the closest customer group identified in the knowledge graph. The reprocessed new campaign content may then be used to recalculate the text similarity scores and update the knowledge graph.

Step 428 begins with the generation of new campaign content, which may be manually created by content developers or automatically generated using language model algorithms such as GPT or BERT. The generated content is analyzed by the text reformation module to identify thematic elements and keywords that resonate with the interests of the target customer group as determined by the knowledge graph.

Once the thematic alignment is established, the text reformation module applies a series of transformations to the new campaign content. This includes the duplication of keywords and phrases identified as central to the interests of the target customer group to emphasize their presence in the content. Conversely, terms that are deemed less relevant or that could potentially dilute the thematic focus are strategically minimized or removed from the content.

The reformed campaign content is integrated into the knowledge graph as a new node. The integration process involves calculating the text similarity scores between the new campaign node and existing nodes using sentence embedding models. These models generate vector representations of the text, which are then compared using similarity metrics such as cosine similarity to determine the strength of the connections.

The new campaign integration step 430 connects the new campaign as a new node to the knowledge graph based on the recalculated similarity to existing collaborative groups. This step may involve adding a new node to the knowledge graph to represent the new campaign and creating edges between the new node and existing nodes based on the recalculated text similarity scores and collaborative consumption data. The new campaign integration step 430 may ensure that the knowledge graph accurately reflects the current state of the campaigns and user interests, thereby enabling the delivery of more personalized and relevant content to the users.

The targeted user connection step 432 uses the updated knowledge graph to target users associated with the collaborative groups that are similar to the new campaign. This step may involve identifying the users who are associated with the collaborative groups that have a high similarity to the new campaign and delivering the new campaign to these targeted users. The targeted user connection step 432 may enhance the effectiveness of the campaign by ensuring that it is delivered to users who are likely to be interested in the content of the campaign.

The overall solution described herein may be illustrated by the following example use case. Consider the example of a financial services company that specializes in investment products for young professionals. The company aims to launch a new campaign promoting an innovative investment app designed to appeal to tech-savvy individuals who are just beginning to build their investment portfolios. Utilizing the collaborative components framework for textual-based recommendations system, the company constructs a knowledge graph from user interactions with past financial campaigns and identifies a customer group with a high affinity for technology and investment education.

The system processes the new campaign content (manually generated or LLM generated), which initially reads “Invest Smart: Get ahead with our new investment app,” to align with the interests of the closest customer group identified in the knowledge graph. Based on the text reformation instructions, the campaign content is modified to emphasize words such as “innovative,” “tech-savvy,” and “educational,” which are prevalent within the targeted customer group's consumption patterns. Conversely, general terms like “savings” and “retirement,” which may dilute the campaign's appeal to the younger audience, are minimized.

The revised campaign content, “Innovative Investment: Become a tech-savvy investor with our educational app,” is integrated into the knowledge graph as a new node. The system recalculates the text similarity scores and updates the graph, strengthening the connection between the new campaign and the nodes representing the tech-oriented investment group. The updated knowledge graph is used to target users within this group, ensuring that the campaign reaches individuals who are more likely to engage with content that resonates with their specific interests in technology and investment learning.

By leveraging the collaborative components framework, the financial services company successfully delivers the new campaign to a precisely targeted audience, resulting in higher engagement rates and a more effective marketing strategy. The system's dynamic nature allows for continuous refinement of the knowledge graph as user interactions evolve, ensuring that future campaigns can be just as accurately targeted.

In pursuit of refining the algorithm's performance, the system incorporates a feedback loop that analyzes the engagement metrics of revised campaign content. These metrics include, but are not limited to, user click-through rates, conversion rates, time spent on content, and social sharing frequencies. By comparing these metrics against those of previous or non-revised campaigns, the system gains insights into the effectiveness of the text modifications.

The algorithm's adaptability is central to its ability to refine the process of selecting words for emphasis and the methods employed to modify the campaigns. For instance, if a revised campaign demonstrates a higher engagement rate, the algorithm may reinforce the campaign generation, selection criteria and modification techniques that contributed to its success. This reinforcement is achieved through a reinforcement learning approach, where the model is rewarded for successful outcomes, leading to the strengthening of the predictive associations between emphasized words and user engagement.

Conversely, if the campaign underperforms, the algorithm may adjust its parameters to better align with user preferences and consumption patterns. This adjustment process involves a Bayesian optimization technique that iteratively updates the model's parameters to increase (e.g., maximize) the likelihood of achieving higher engagement rates. The optimization process considers a range of parameters, including the selection of emphasis words, the frequency of their occurrence, and the context in which they are used.

The adjustments to the algorithm may include fine-tuning the NLP techniques used to identify emphasis words. This fine-tuning process may involve refining the sentence embedding models to better capture the nuances of user interests. For example, the system may employ transfer learning to adapt pre-trained sentence embedding models, such as BERT or GPT, to the specific domain of the campaigns, thereby enhancing the model's ability to discern contextually relevant emphasis words.

Additionally, the algorithm may alter the threshold levels for emphasizing or minimizing words, ensuring that the modifications to the campaign content are both effective and contextually appropriate. The system may employ an algorithm to evolve the threshold levels over successive generations, selecting the fittest thresholds that yield the optimum balance between emphasis and minimization for improved user engagement.

The system may also incorporate machine learning models that learn from the performance data of campaigns, enabling the algorithm to predict more accurately which words and phrases will resonate with the target audience. These predictive models may include supervised learning algorithms such as random forests or gradient boosting machines, which are trained on historical campaign performance data to identify patterns that correlate with high engagement.

Moreover, the algorithm may evolve the way campaigns are modified by integrating user feedback and interaction data into the text reformation process. This data-driven approach allows for a more dynamic and responsive system that can quickly adapt to changes in user behavior and preferences. The system may implement an online learning framework that continuously updates the model in real-time as new data streams in, allowing the algorithm to respond promptly to shifts in user engagement trends.

By continuously learning from the performance outcomes of revised campaigns, the algorithm enhances its ability to deliver personalized and engaging content, thereby optimizing the effectiveness of the textual-based recommendation system. The system may utilize testing to experiment with different text reformations, systematically comparing the performance of variants to identify the modifications that yield improved impact on user engagement. This experimental approach provides empirical evidence to guide the ongoing optimization of the algorithm, ensuring that the system remains at the forefront of delivering tailored and compelling campaign content.

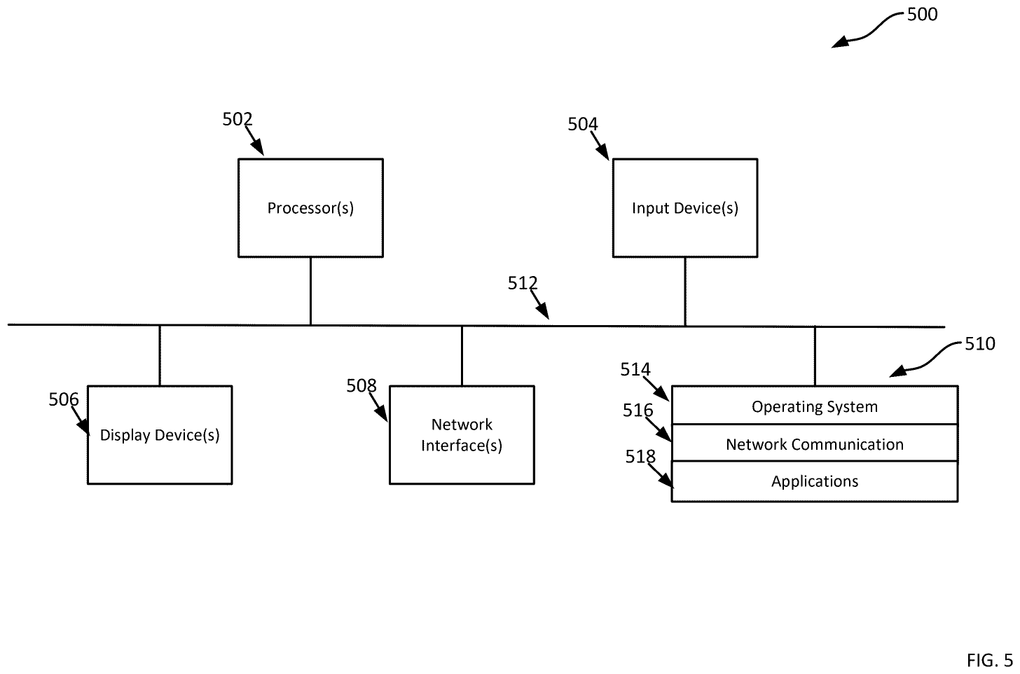

Referring now to FIG. 5, a block diagram of a computing system diagram 500 is depicted and now described. The computing system diagram 500 may represent a computing environment in which the system 100 for providing textual-based recommendations may be implemented. The computing system diagram 500 includes central processing units 502, user input devices 504, a visual output display 506, network connectivity hardware 508, and a software layer 510, all interconnected via a system communication bus 512.

The central processing units 502 may serve as the computational core of the computing system diagram 500. In some cases, the central processing units 502 may be configured to execute various software components, including but not limited to, the knowledge graph constructing module, the reciprocal graph reintegration module, and the text reformation module of the recommendation server 106. The central processing units 502 may also be configured to perform various operations related to the construction of the knowledge graph, the adjustment of edge weights within the knowledge graph, and the processing of new campaign content.

The user input devices 504 may provide a means for user interaction with the computing system diagram 500. In some aspects, the user input devices 504 may include various types of input devices, such as a keyboard, a mouse, a touch screen, a microphone, or any other device capable of receiving user input. The user input devices 504 may be used to input campaign content data, user interaction data, or any other relevant data into the computing system diagram 500.

The visual output display 506 may present visual information to the user. In some cases, the visual output display 506 may be configured to display the network graph, the campaign content table, or any other visual representation of the data processed by the computing system diagram 500. The visual output display 506 may also be used to display the results of the textual-based recommendations, such as the targeted recipients of the campaign or the effectiveness of the campaign.

The network connectivity hardware 508 may enable network communication between the computing system diagram 500 and other devices or systems, such as the user device 102, the database 104, or the recommendation server 106. In some aspects, the network connectivity hardware 508 may be configured to transmit and receive data over the network cloud 108, which may represent any type of network, including but not limited to, the internet, a local area network (LAN), a wide area network (WAN), a virtual private network (VPN), or any combination thereof.

The software layer 510 encompasses core system software 514, network data management software 516, and user application programs 518. The software layer 510 indicates the layered architecture of the computing system diagram 500, where the software components interface with the hardware components through the system communication bus 512. The core system software 514 may include various system-level software components, such as an operating system, device drivers, or any other software that provides basic functionality for the computing system diagram 500. The network data management software 516 may include various software components for managing network data, such as a web browser, a network protocol stack, or any other software that facilitates network communication. The user application programs 518 may include various software applications that provide user-level functionality, such as a word processor, a spreadsheet program, a database management system, or any other software that provides specific functionality for the user.

In some aspects, the computing system diagram 500 may be configured to execute the system 100 for providing textual-based recommendations. The system 100 may be implemented as a software application running on the computing system diagram 500, utilizing the central processing units 502, the user input devices 504, the visual output display 506, the network connectivity hardware 508, and the software layer 510 to provide textual-based recommendations based on a user-specific knowledge graph. The computing system diagram 500 may provide a flexible and scalable platform for implementing the system 100, thereby enabling the delivery of more personalized and relevant content to users.

While the foregoing is directed to example embodiments described herein, other and further example embodiments may be devised without departing from the basic scope thereof. For example, aspects of the present disclosure (e.g., modules) may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are not limiting. It is intended that permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A system for providing content-based recommendations, comprising:
a database comprising campaign content data from text-based campaigns; and
a server including a processor configured to:
construct a knowledge graph from text-based campaign content data received via electronic text-based content delivery, wherein the knowledge graph is constructed to include nodes representing individual text-based campaigns and edge weights representing content similarity determined using natural language processing and collaborative consumption between text-based campaigns and user interaction data received via electronic communication;
adjust the edge weights within the knowledge graph based on the collaborative consumption of customer groups, by increasing edge weights for campaign node pairs consumed by a common collaborative group and decreasing edge weights for campaign node pairs consumed by different groups, to emphasize common keywords belonging to common customer groups and deemphasize keywords belonging to different customer groups; and
process new text-based campaign content by modifying text through keyword emphasis and minimization to align with interests of a closest customer group of the customer groups identified in the knowledge graph, thereby enabling targeted delivery of the new text-based campaign to customers associated with that group via electronic text-based content delivery.

2. The system of claim 1, wherein the processor is further configured to collect the text-based campaign content data from a plurality of sources, including social media platforms, email campaigns, and web advertisements.

3. The system of claim 1, wherein the processor is further configured to represent each campaign as a node within the knowledge graph based on the text-based campaign content data.

4. The system of claim 1, wherein the processor is further configured to apply natural language processing techniques to determine content similarity scores between pairs of campaign nodes.

5. The system of claim 4, wherein the natural language processing techniques include a use of sentence embedding models to determine the content similarity scores between the campaign nodes.

6. The system of claim 1, wherein the processor is further configured to increase the edge weights for pairs of campaign nodes that are consumed by a collaborative group of content consumers, thereby enhancing the content similarity within the collaborative group.

7. The system of claim 1, wherein the processor is further configured to decrease the edge weights for pairs of campaign nodes that are not consumed by common collaborative group of content consumers, thereby reducing the content similarity across different collaborative groups.

8. The system of claim 1, wherein the processor is further configured to utilize the user interaction data to identify the common customer groups, such data including but not limited to click-through rates, content consumption time, and sharing metrics.

9. The system of claim 1, wherein the processor is further configured to dynamically adjust the edge weights in response to changes in the user interaction data, ensuring that the knowledge graph reflects current consumption patterns.

10. The system of claim 1, wherein the processor is further configured to apply a decay factor to the edge weights over time, to account for an evolving interests of the common customer groups and maintain a relevance of the knowledge graph.

11. A method for providing content-based recommendations, comprising the steps of:
constructing, by a processor of a server, a knowledge graph from text-based campaign content data from a database using a knowledge graph constructing module, wherein the text-based campaign content data includes data from text-based campaigns and the knowledge graph includes nodes representing individual text-based campaigns and edges with weights representing content similarity using natural language processing and collaborative consumption between text-based campaigns and user interaction data received via electronic communication;
adjusting the edge weights within the knowledge graph based on the collaborative consumption of customer groups, by increasing edge weights for campaign node pairs consumed by a common collaborative group and decreasing edge weights for campaign node pairs consumed by different groups, to emphasize common keywords belonging to common customer groups and deemphasize keywords belonging to different customer groups; and
processing new text-based campaign content by modifying text through keyword emphasis and minimization to align with interests of a closest customer group of the customer groups identified in the knowledge graph, thereby enabling targeted delivery of the new text-based campaign to customers associated with that group via electronic text-based content delivery.

12. The method of claim 11, further comprising the step of collecting the text-based campaign content data from a plurality of sources, including social media platforms, email campaigns, and web advertisements.

13. The method of claim 11, further comprising the step of representing each campaign as a node within the knowledge graph based on the text-based campaign content data.

14. The method of claim 11, further comprising the step of applying natural language processing techniques to determine content similarity scores between pairs of campaign nodes.

15. The method of claim 14, wherein the natural language processing techniques include the step of using sentence embedding models to determine the content similarity scores between the campaign nodes.

16. The method of claim 11, further comprising the step of increasing the edge weights for pairs of campaign nodes that are consumed by a collaborative group of content consumers, thereby enhancing the content similarity within the collaborative group.

17. The method of claim 11, further comprising the step of decreasing the edge weights for pairs of campaign nodes that are not consumed by common collaborative group of content consumers, thereby reducing the content similarity across different collaborative groups.

18. The method of claim 11, further comprising the step of utilizing the user interaction data to identify the common customer groups, such data including but not limited to click-through rates, content consumption time, and sharing metrics.

19. The method of claim 11, further comprising the step of dynamically adjusting the edge weights in response to changes in the user interaction data, ensuring that the knowledge graph reflects current consumption patterns.

20. The method of claim 11, further comprising the step of applying a decay factor to the edge weights over time, to account for an evolving interests of the common customer groups and maintain a relevance of the knowledge graph.
